(19) United States
(12) Patent Application Publication
(10) Pub. No.: US 2015/0119043 A1
(43) Pub. Date: Apr. 30, 2015

(54) PRUNING TARGET INTER-RADIO ACCESS TECHNOLOGY (IRAT) HANDOVER CANDIDATE CELLS

(71) Applicant: QUALCOMM Incorporated, San Diego, CA (US)

(72) Inventors: Thawatt GOPAL, San Diego, CA (US); Qingxin CHEN, Del Mar, CA (US); Tom CHIN, San Diego, CA (US)

(73) Assignee: QUALCOMM Incorporated, San Diego, CA (US)

(21) Appl. No.: 14/068,889

(22) Filed: Oct. 31, 2013

(51) Int. Cl. H04W 36/00; H04W 88/06

(52) U.S. Cl. CPC H04W 36/0061; H04W 88/06
USPC 455/437; 455/552.1

(57) ABSTRACT

A method of wireless communication includes determining a threshold based on a signal strength of a strongest candidate target cell of a target radio access technology (RAT) and a previous serving cell of the target RAT. The method also includes pruning a list of candidate target cells of the target RAT based on the threshold. The list is pruned for a handover from a source RAT. The method further includes reporting the pruned list to a base station of the source RAT prior to the handover.

### BACKGROUND

1. Field

Aspects of the present disclosure relate generally to wireless communication systems, and more particularly, to a pruning algorithm for pruning target inter-radio access technology (IRAT) handover candidate cells for improving IRAT handover success in a multi-mode UE operating in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes determining a threshold based on a signal strength of a strongest candidate target cell of a target radio access technology (RAT) and one or more previous serving cells of the target RAT. The method also includes pruning a list of candidate target cells of the target RAT based on the threshold. The list is pruned for a handover from a source RAT. The method further includes reporting the pruned list to a base station of the source RAT prior to the handover.

Another aspect discloses an apparatus including means for determining a threshold based on a signal strength of a strongest candidate target cell of a target RAT and one or more previous serving cells of the target RAT. The apparatus also includes means for pruning a list of candidate target cells of the target RAT based on the threshold. The list is pruned for a handover from a source RAT. The apparatus further includes means for reporting the pruned list to a base station of the source RAT prior to the handover.

In yet another aspect, a computer program product for wireless communications in a wireless network having a non-transitory computer-readable medium is disclosed. The computer readable medium has non-transitory program code recorded thereon which, when executed by the processor(s), causes the processor(s) to perform operations of determining a threshold based on a signal strength of a strongest candidate target cell of a target RAT and one or more previous serving cells of the target RAT. The program code also causes the processor(s) to prune a list of candidate target cells of the target RAT based on the threshold. The list is pruned for a handover from a source RAT. The program code further causes the processor(s) to report the pruned list to a base station of the source RAT prior to the handover.

Still another aspect discloses wireless communication having a memory and at least one processor coupled to the memory. The processor(s) is configured to determine a threshold based on a signal strength of a strongest candidate target cell of a target RAT and one or more previous serving cells of the target RAT. The processor(s) is also configured to prune a list of candidate target cells of the target RAT based on the threshold. The list is pruned for a handover from a source RAT. The processor(s) is further configured to report the pruned list to a base station of the source RAT prior to the handover.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates a timing diagram of an IRAT handover according to an aspect of the present disclosure.

FIG. 6 is a block diagram illustrating a method for pruning a list of candidate target cells according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

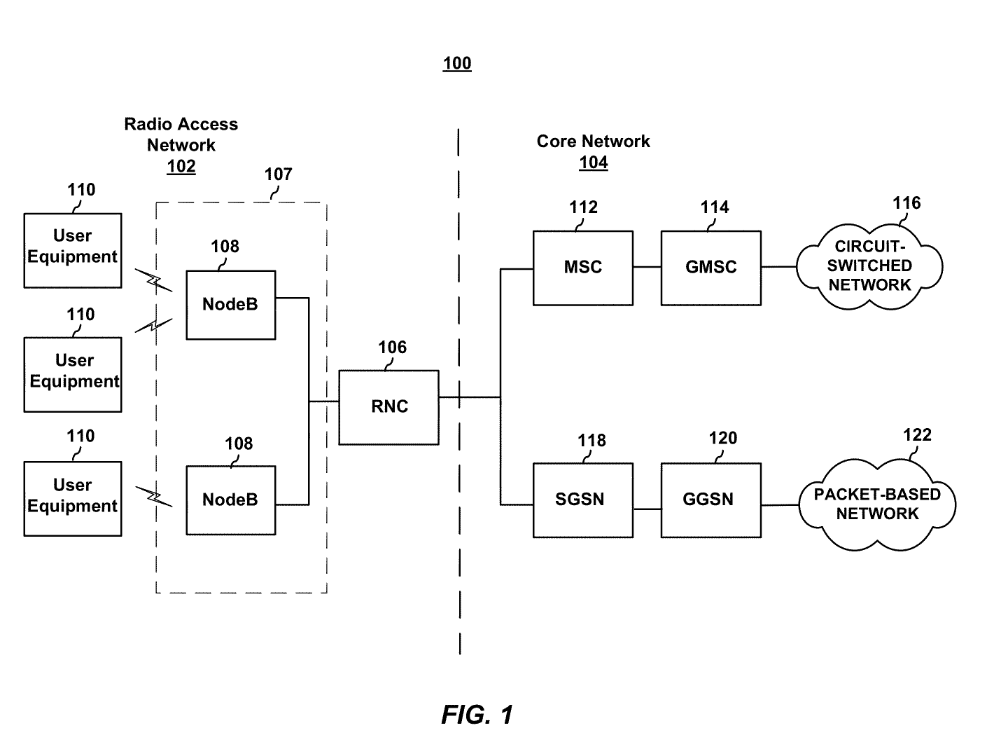

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

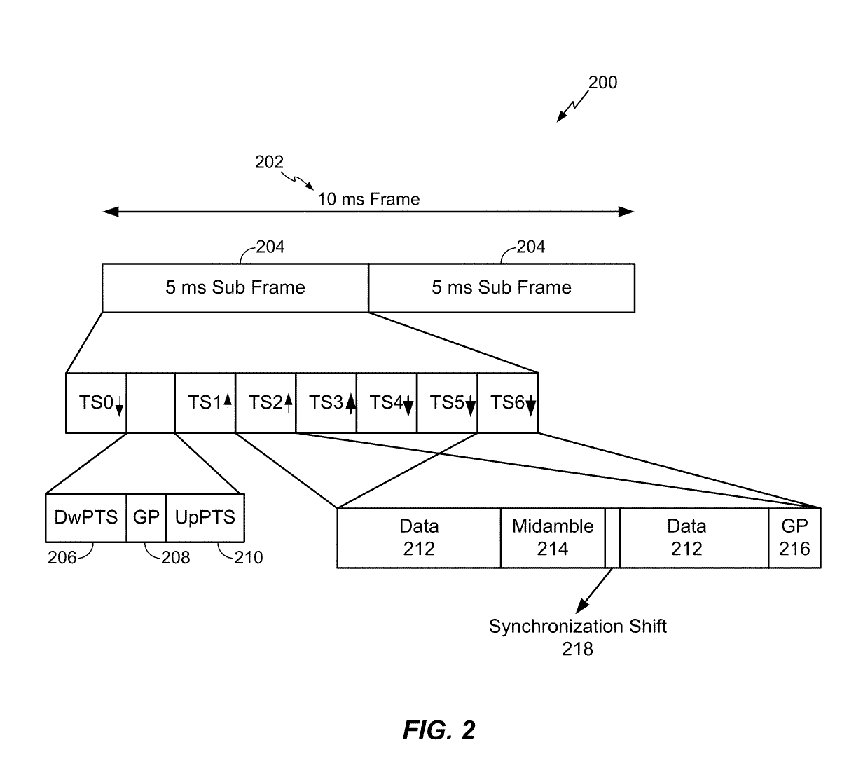

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

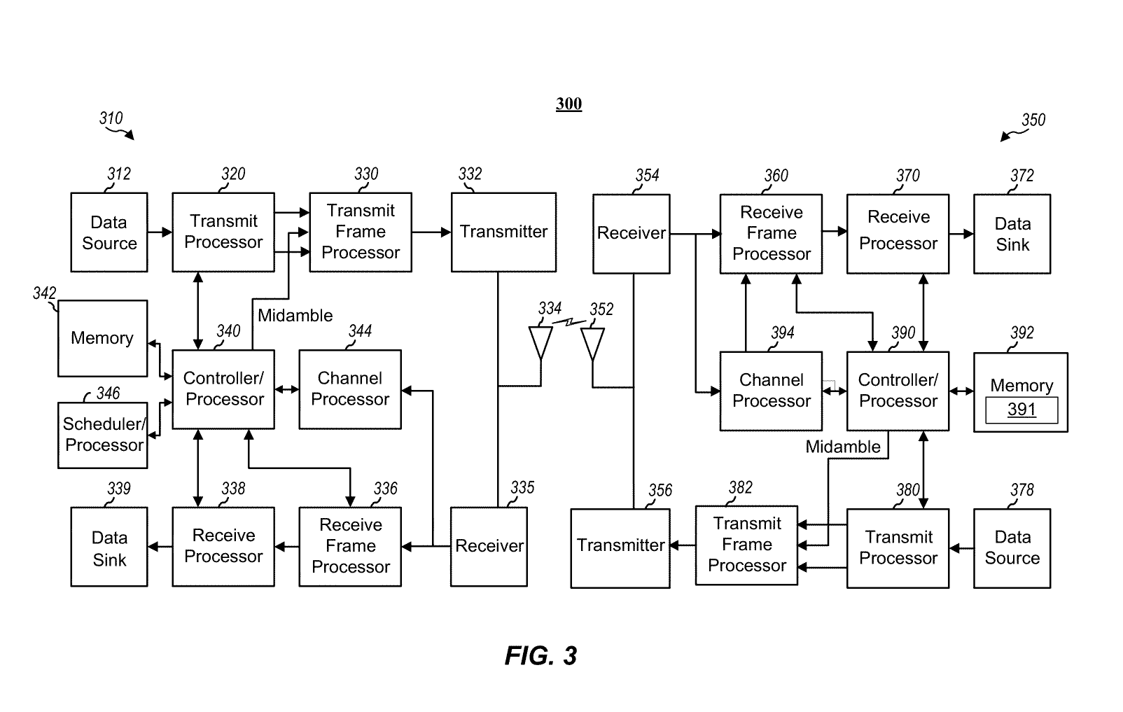

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a handover candidate pruning module 391 which, when executed by the controller/processor 390, configures the UE 350 for pruning candidate cells for a potential IRAT handover. A scheduler/processor 346 at the node B 310 may be used to allocate resources to the UEs and schedule downlink and/or uplink transmissions for the UEs.

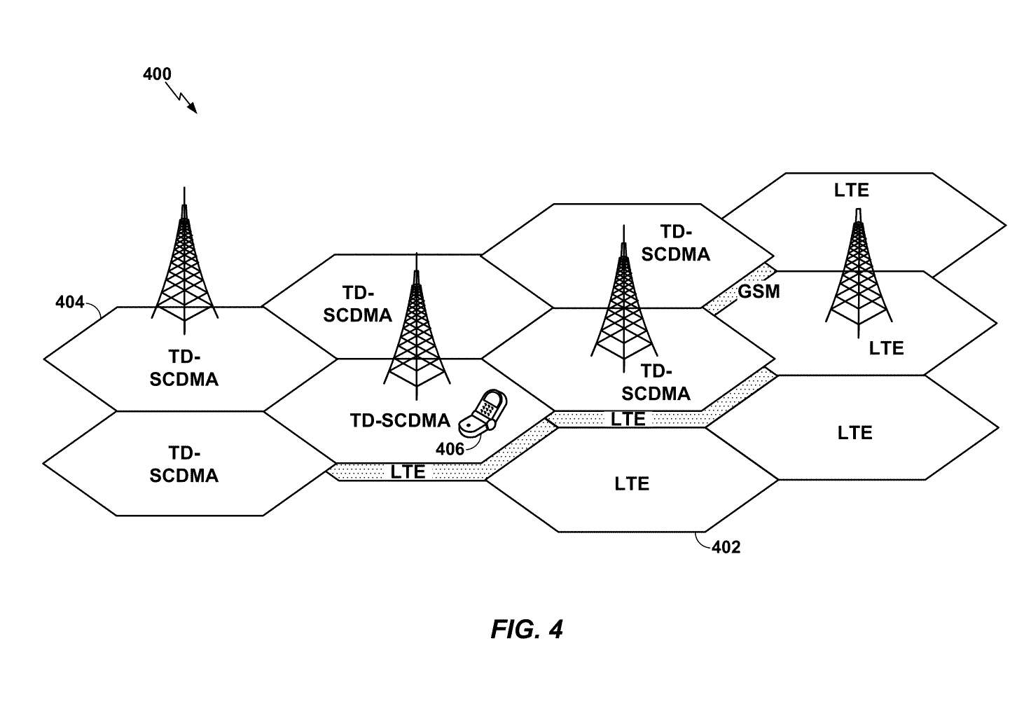

FIG. 4 illustrates coverage of a newly deployed network, such as a TD-SCDMA network and also coverage of a more established network, such as an LTE network. A geographical area 400 may include LTE cells 402 and TD-SCDMA cells 404. A user equipment (UE) 406 may move from one cell, such as a TD-SCDMA cell 404, to another cell, such as an LTE cell 402. The movement of the UE 406 may specify a handover or a cell reselection.

The handover or cell reselection may be performed when the UE moves from a coverage area of a TD-SCDMA cell to the coverage area of an LTE cell, or vice versa. A handover or cell reselection may also be performed when there is a coverage hole or lack of coverage in the TD-SCDMA network or when there is traffic balancing between the TD-SCDMA and LTE networks. As part of that handover or cell reselection process, while in a connected mode with a first system (e.g., TD-SCDMA) a UE may be specified to perform a measurement of a neighboring cell (such as LTE cell). For example, the UE may measure the neighbor cells of a second network for signal strength, frequency channel, and base station identity. The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a LTE neighbor cell received signal strength indicator (RSSI). The neighbor cell signal strength can be compared with a neighbor system threshold.

Other radio access technologies, such as a wireless local area network (WLAN) or WiFi may also be accessed by a user equipment (UE) in addition to cellular networks such as TD-SCDMA or LTE. For the UE to determine nearby WiFi access points (APs), the UE scans available WiFi channels to identify/detect if any WiFi networks exist in the vicinity of the UE. In one configuration, the UE may use TD-SCDMA reception/transmission gaps to switch to the WiFi network to scan the WiFi channels.

### Target IRAT Handover Candidate Cell Pruning

An IRAT handover may switch a connected mode UE between a first network, such as an LTE network, and a second network, such as a TD-SCDMA network. Aspects of the present disclosure discuss a handover from an LTE network to a TD-SCDMA network. Still, the aspects of the present disclosure are not limited to a handover from an LTE network to a TD-SCDMA network and are also contemplated for any handover from a first network to a second network.

In one configuration, when associated with a first network, the UE measures one or more cell frequencies of a second network to determine candidate cells for an IRAT handover. The first network may be associated with a RAT that is different from the RAT of the second network. The measurements may be made using network configured measurement objects and/or gaps when the UE is in a connected mode. The measurement objects may include specific cells and/or frequencies to measure. Furthermore, after measuring the one or more cell frequencies of a second network, the UE may report, to the first network, one or more candidate cells of the second network that meet a pre-defined condition, such as having a signal strength greater than or equal to a threshold. In one configuration, the report includes the strongest cell and additional cells that were also detected and measured during the measurements of cell frequencies of the second network.

In a typical system, the first network may select the strongest cell included in the measurement report as the target cell. Still, in some cases, the first network may not select the strongest cell of the second network as the target cell. For example, the strongest cell may be in a congestion state and may not have additional resources, such as radio resources and/or hardware resources, to support the handover. Therefore, in the present example, the first network may not select the strongest cell as the target cell for a handover.

In another example, the first network may not select the strongest cell as the target cell for a handover due to network transport layer congestion between the source cell of a first network and target cell of a second network. In this example, there may be multiple target cells that do not belong to the same base station controller (BSC). Therefore, some of the target cells may have a different transport layer topology and experience different transport layer related congestion and associated delays. In this example, the strongest target cell's transport layer may experience congestion and may be unable to respond to source cell's request to allocate resources on the target cell within a certain time. Therefore, the first network may not select the strongest cell as the target cell for a handover.

In yet another example, some of the target cells may be cells on a femto network, pico network, micro network, or macro network. In some cases, the source network may implement a resource allocation policy to prioritize femto/pico/micro target cells over target cells associated with macro networks to offload congestion on a target macro network even though the femto/pico/micro target cells may not be the strongest candidate cell. Therefore, in this example, the first network may not select the strongest cell as the target cell for a handover.

Some networks, such as TD-SCDMA networks, are interference limited systems. Specifically, in an interference limited system, the handover procedure may fail when the UE is directed to a target cell that is not the strongest cell among the candidate cells. That is, the handover procedure may fail due to interference from the strongest candidate cell or other candidate cell(s) that is stronger than the target cell. Thus, it is desirable to mitigate handover failures by pruning weak cells from the list of potential candidate cells for an IRAT handover.

It should be noted that in some cases, a UE, such as a TD-SCDMA UE, may use interference cancellation techniques to mitigate interference. Aspects of the present disclosure may be specified for UEs that use interference cancellation techniques to mitigate interference because of the use of relative threshold. Alternatively, aspects of the present disclosure may also be specified for UEs that do not use interference cancellation techniques to mitigate interference

Aspects of the present disclosure are directed to pruning the list of candidate target cells for an IRAT handover prior to transmitting a measurement report to a base station of the source network. In one configuration, a list of candidate target cells is pruned based on an observed success rate of previous IRAT handovers to target cells that are not the strongest cells among the candidate cells.

In one configuration, an observation window is defined. The observation window may include a list of previously successful IRAT handover events from the first network to the second network in which the target cell was not the strongest cell from the list of potential candidate cells. The number of handover events in the list may be a pre-determined number or may be set by the user.

In one configuration, after determining the number of previously successful handover events for the observation window, the UE may determine the weakest previous serving cell from the list of previous handover events. For example, the number for previous IRAT handover events may be ten and the UE determines the weakest previous serving cell from the ten previous handover events. In the present configuration, after determining the weakest previous serving cell from the list of previous handover events, the UE determines a handover threshold value based on a difference between the strongest current candidate cell and the signal strength of the weakest previous serving cell. The strongest current candidate cell refers to the candidate cell for a current potential IRAT handover having a signal strength that is greater than the other candidate cells. Furthermore, the cells of the second network in the list of previous handover events may be referred to as previous serving cells. Moreover, IRAT handover events may be referred to as handover events.

In one configuration, the weakest previous serving cell may be determined by calculating the difference between the strongest current candidate cell and the signal strength of each previous serving cell in the list of previously successful handover events. For example, if the list of previously successful handover events includes ten handover events, the values {d1, d2, . . . , d10} are the determined differences between a signal strength of the strongest current candidate cell and the signal strength of each previous serving cell for ten previous serving cells of the second network. It should be noted that the values {d1, d2, . . . , d10} are non-zero values. Specifically, a zero value indicates that the strongest current candidate cell was the actual previous serving cell.

In the present configuration, based on the values in the list of previously successful handover events, the UE determines a handover threshold value based on the maximum value in the list (e.g., max{d1, d2, . . . , d10}). The maximum value may be the value of the greatest difference between the signal strength of strongest current candidate cell and the signal strength of each previous serving cell in the list of successful handover events.

In one configuration, the handover list is dynamically updated by the UE based on subsequent handovers. That is, for subsequent handovers, the UE maintains the handover list of the pre-determined number of most recent successful handovers to cells that have a signal strength that is less than the signal strength of the strongest cell.

Based on an aspect of the present disclosure, after determining the handover threshold value, the UE transmits the handover threshold value to a stack for the first network. Alternatively, the first network stack may determine the handover threshold value. Based on the handover threshold value, the first network stack may prune candidate cells of the second network. The candidate cells of the second network are determined based on the IRAT search/measurement performed in response to a message, such as a connection reconfiguration message, received from the first network.

The stack for the first network refers to the software stack of the UE associated with the first network. Likewise, the stack for the second network refers to the software stack of the UE associated with the second network. For example, if the first network is an LTE network, the stack for the first network would be referred to as the LTE stack. Additionally, the stack for the first network may be referred to as the first network stack.

In one configuration, for each candidate in a list of potential handover candidates, the first network stack determines whether the difference between the signal strength of the strongest candidate cell and the signal strength of the selected candidate cell is greater than the handover threshold value. In this configuration, if the difference is greater than the handover threshold value, the selected candidate is removed from the list of potential handover candidates. Alternatively, if the difference is equal to or less than the handover threshold value, the selected candidate may remain on the list of potential handover candidates. Moreover, in the present configuration, the first network stack performs the pruning operation for all of the candidates in the list of potential handover candidates. In the present application, the candidate cells of the second network for an IRAT handover may be referred to as candidates.

After pruning the list of potential handover candidates, the first network stack transmits the pruned list of potential handover candidates to the first network. The first network may then select a target cell from the pruned list of potential handover candidates. In one configuration, after selecting the target cell, the first network transmits the selected target cell to the first network stack. The selected target cell may be transmitted in a handover command message. In response to receiving the target cell from the first network, the first network stack of the UE transmits the handover command to the second network stack of the UE. In one configuration, the handover command includes the un-pruned list of potential handover candidates, a signal strength and cell ID of the strongest candidate cell, the selected target cell, and/or a handover container transmitted by the network. The handover container may be specified to facilitate the establishment of the physical channel on the target cell. Additionally, it should be noted that the first network stack and the second network stack are defined within the same UE.

Based on the information received from the first network stack, the second network stack establishes a connection with the second network. That is, the UE is handed over to the second network from the first network. In one configuration, when the selected target cell is not the strongest candidate cell, after establishing the connection with the second network, the second network stack initiates the pruning algorithm to determine a new handover threshold value based on the most recent connection. Specifically, based on the pre-determined number of the previous successful connection to the second network (including the most recent connection) and the most recent reported strongest candidate cell, the second network stack determines a new threshold handover value. After determining the new threshold handover value, the second network stack transmits the new threshold handover value to the first network stack. In this configuration, the first network stack will use the new threshold handover value in the next iteration of the pruning of the candidate cells for an IRAT handover.

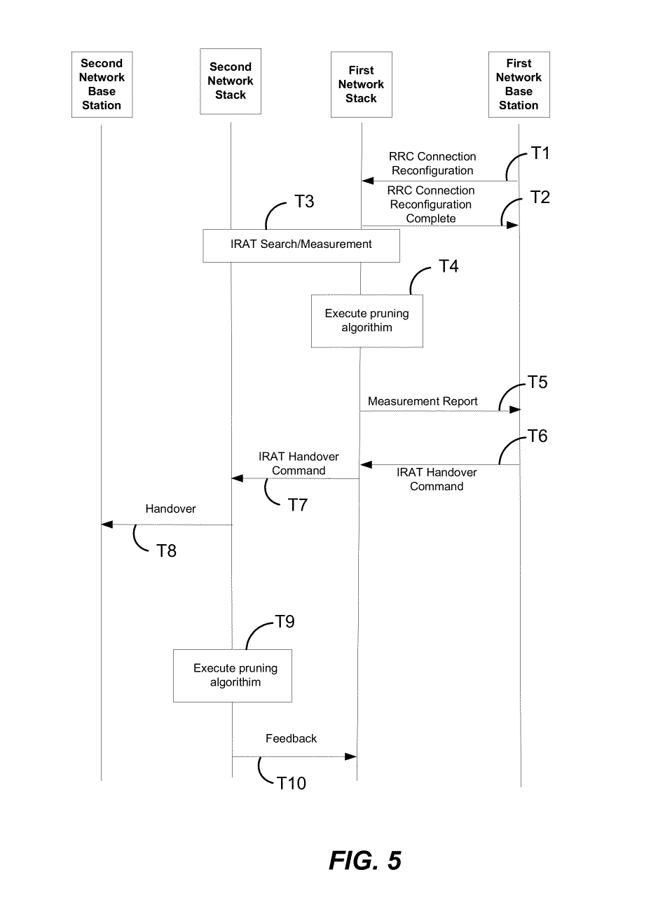

FIG. 5 illustrates a timing diagram for an IRAT handover according to an aspect of the present disclosure. As shown in FIG. 5, at time T1 the base station of the first network may transmit an RRC connection reconfiguration message to the first network stack of a UE. The RRC connection reconfiguration message may be specified to initiate the IRAT measurements (see time T3). Furthermore, at time T2, the first network stack transmits an RRC connection reconfiguration complete message to the base station of the first network. The RRC connection reconfiguration complete message may be specified to acknowledge the RRC connection reconfiguration message. It should be noted that in the present application, a cell may be referred to as a base station.

In response to the RRC connection reconfiguration message, at time T3, the first network stack and the second network stack of the UE perform a search and measurement procedure for an IRAT handover from the first network to the second network. A list of potential candidate cells for the IRAT handover is derived based on the search and measurement procedure. The list of potential candidate cells may include an ID and a signal strength of each cell.

In the present configuration, at time T4, the first network stack executes a pruning algorithm on the list of potential candidate cells. As previously discussed, the list of potential candidate cells is pruned based on a handover threshold value. The handover threshold value is derived from a list of a pre-determined number of previously successful handover events. Specifically, the handover threshold value is determined by calculating the value of the greatest difference between the candidate cell with the greatest signal strength and the signal strength of one of the previous serving cells in the list of previously successful handover events.

As an example, the list of potential candidate cells derived from the search/measurement of time T3 may yield the list {Cell_A, Cell_B, Cell_C, Cell_D}, where Cell_A is the strongest cell. In the present example, after pruning based on the handover threshold value, the list of candidate cells is {Cell_A, Cell_C}. That is, in the present example, the difference between the signal strength of Cell_A and Cell_B is greater than the determined handover threshold value. Likewise, in the present example, the difference between the signal strength of Cell_A and Cell_{D} is greater than the determined handover threshold value. More specifically, Cell_B and Cell_D are weaker than Cell_A by an amount that is greater than the handover threshold value.

The pruned list of potential candidate cells may improve the IRAT handovers. Specifically, because Cell_B and Cell_D are weaker than Cell_A by an amount that is greater than the handover threshold value, the probability of a successful handover to either Cell_B or Cell_D is decreased. Therefore, Cell_B and Cell_D are pruned from the list of potential candidate cells to increase the likelihood of a handover to one of the cells that remain on the list of potential candidate cells.

After pruning the list of potential candidate cells, at time T5, the first network stack transmits a measurement report to the first network base station. The measurement report may include the pruned list of potential candidate cells. The first network base station may determine a target cell for the IRAT handover based on the received pruned list of potential candidate cells. At time T6, the first network base station transmits the IRAT handover command to the first network stack. The IRAT handover command may include information for the target cell and/or a handover container including a list of parameters for setting up the connection with the second network. In response to receiving the IRAT handover command, at time T7, the first network stack may forward the IRAT handover command to the second network stack. The IRAT handover command forwarded to the second network stack includes the target cell information, the handover container, an un-pruned list of potential candidate cells, the signal strength and cell ID of the strongest candidate cell, and/or the signal strengths of the other cells in the list of potential candidate cells. That is, the first network stack adds additional information to the information provided by the first network base station in the IRAT handover command.

After receiving the IRAT handover command from the first network, at time T8, the second network stack completes the handover to the second network base station. Furthermore, at time T9, if the handover was to a cell that was not the strongest cell in the list of potential candidate cells, the second network stack updates the list of previous successful handovers so that the handover threshold value is updated based on the most recent handover. Specifically, the handover threshold value may be updated based on the pre-determined number of previous successful handovers, the signal strength of the most recent target cell, and the cell ID and signal strength of the strongest candidate cell last reported by the first network stack.

Moreover, if the handover was to a cell that was not the strongest cell in the list of potential candidate cells, at time T10 the second network stack transmits the updated handover threshold value to the first network stack. In the present configuration, the first network stack uses the updated handover threshold value for subsequent IRAT handovers.

*** Inventors: we may update the paragraphs below after claims are approved ***

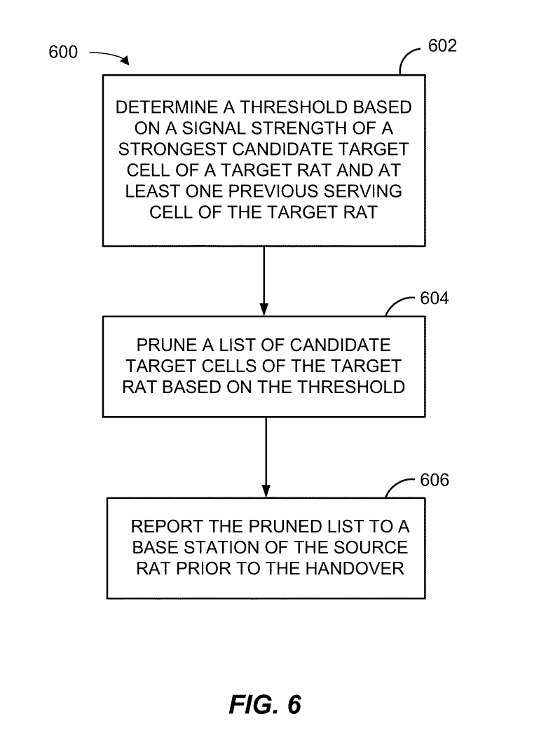

FIG. 6 shows a wireless communication method 600 according to one aspect of the disclosure. A UE determines a threshold based on a signal strength of a strongest candidate target cell of a target RAT and a at least one previous serving cell of the target RAT, as shown in block 602. Additionally, the UE also prunes a list of candidate target cells of the target RAT based on the threshold as shown in block 604. The list of candidate cells may be pruned for a potential handover to the target RAT. Furthermore, at block 606, the UE reports the pruned list to a base station of the source RAT prior to the handover.

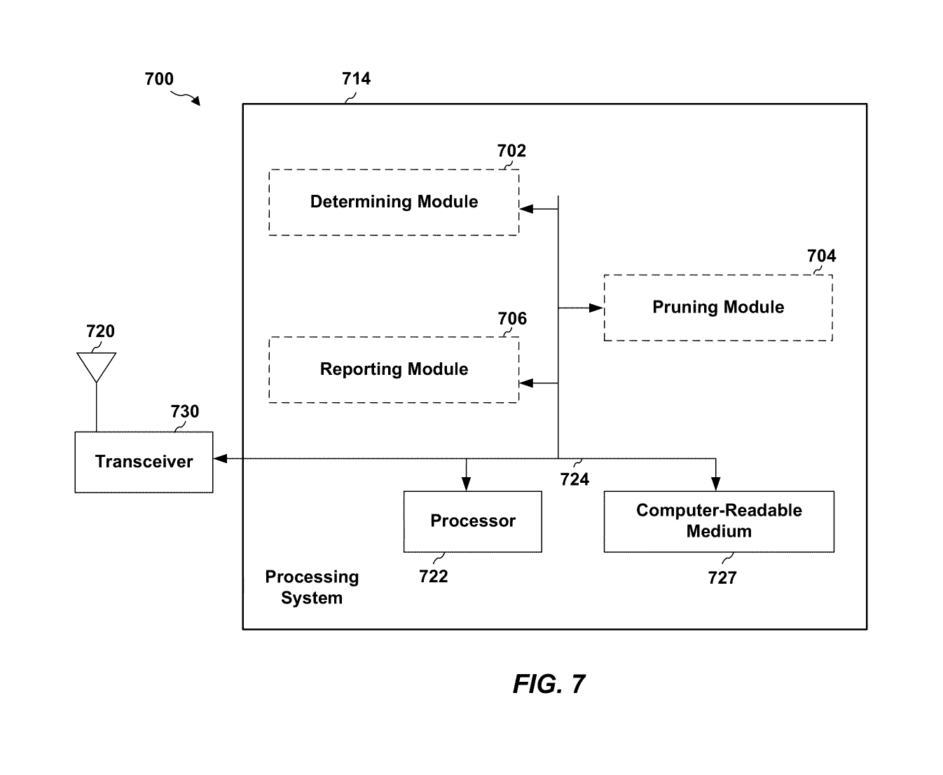

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706 and the computer-readable medium 727. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 727. The processor 722 is responsible for general processing, including the execution of software stored on the computer-readable medium 727. The software, when executed by the processor 722, causes the processing system 714 to perform the various functions described for any particular apparatus. The computer-readable medium 727 may also be used for storing data that is manipulated by the processor 722 when executing software.

The processing system 714 includes a determining module 702 that determines a threshold based on a signal strength of a strongest candidate target cell of a target radio access technology (RAT) and a at least one previous serving cell of the target RAT. The processing system 714 also includes a pruning module 704 for pruning a list of candidate target cells of the target RAT based on the threshold. The processing system 714 also includes a reporting module 706 for reporting the pruned list to a base station of the source RAT prior to the handover. The modules may be software modules running in the processor 722, resident/stored in the computer-readable medium 727, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for determining. In one aspect, the above means may be the channel processor 394, the receive frame processor 360, the receive processor 370, the controller/processor 390, the memory 392, handover candidate pruning module 391, the determining module 702, and/or the processing system 714 configured to perform the functions recited by the determining means.

In another configuration, an apparatus such as a UE is configured for wireless communication including means for pruning. In one aspect, the above means may be the channel processor 394, the receive frame processor 360, the receive processor 370, the transmit frame processor 382, the controller/processor 390, the memory 392, handover candidate pruning module 391, the pruning module 704, and/or the processing system 714 configured to perform the functions recited by the determining means.

In another configuration, an apparatus such as a UE is configured for wireless communication including means for reporting. In one aspect, the above means may be, the antennas 352, the transmit frame processor 382, the transmit processor 380, the controller/processor 390, the memory 392, handover candidate pruning module 391, the reporting module 706, and/or the processing system 714 configured to perform the functions recited by the determining means.

Several aspects of a telecommunications system has been presented with reference to TD-SCDMA and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining, at a UE, a threshold based at least in part on a signal strength of a strongest candidate target cell of a target radio access technology (RAT) and at least one previous serving cell of the target RAT;
pruning a list of candidate target cells of the target RAT, for a handover from a source RAT, based at least in part on the threshold; and
reporting the pruned list to a base station of the source RAT prior to the handover.

2. The method of claim 1, further comprising updating the threshold when a serving cell of a most recent successful handover is weaker than the strongest candidate target cell.

3. The method of claim 1, in which the threshold is further based at least in part on a greatest difference between the signal strength of the strongest candidate target cell and a signal strength of the at least one previous serving cell, each of the at least one previous serving cells being a serving cell based at least in part on a previous successful handover.

4. The method of claim 1, further comprising receiving a target candidate cell from the base station based at least in part on the pruned list.

5. The method of claim 1, in which the at least one previous serving cell of the target RAT was not a strongest candidate target cell at a time of a respective handover to the at least one previous serving cell.

6. The method of claim 1, in which the UE performs interference cancellation during the handover.

7. An apparatus for wireless communications, comprising:
a memory; and
at least one processor coupled to the memory, the at least one processor being configured:
to determine, at a UE, a threshold based at least in part on a signal strength of a strongest candidate target cell of a target radio access technology (RAT) and at least one previous serving cell of the target RAT;
to prune a list of candidate target cells of the target RAT, for a handover from a source RAT, based at least in part on the threshold; and
to report the pruned list to a base station of the source RAT prior to the handover.

8. The apparatus of claim 7, in which the at least one processor is further configured to update the threshold when a serving cell of a most recent successful handover is weaker than the strongest candidate target cell.

9. The apparatus of claim 7, in which the threshold is further based at least in part on a greatest difference between the signal strength of the strongest candidate target cell and a signal strength of the at least one previous serving cell, each of the at least one previous serving cells being a serving cell based at least in part on a previous successful handover.

10. The apparatus of claim 7, in which the at least one processor is further configured to receive a target candidate cell from the base station based at least in part on the pruned list.

11. The apparatus of claim 7, in which the at least one previous serving cell of the target RAT was not a strongest candidate target cell at a time of a respective handover to the at least one previous serving cell.

12. The apparatus of claim 7, in which the at least one processor is configured to perform interference cancellation during the handover.

13. An apparatus for wireless communications, comprising:
means for determining, at a UE, a threshold based at least in part on a signal strength of a strongest candidate target cell of a target radio access technology (RAT) and at least one previous serving cell of the target RAT;
means for pruning a list of candidate target cells of the target RAT, for a handover from a source RAT, based at least in part on the threshold; and
means for reporting the pruned list to a base station of the source RAT prior to the handover.

14. The apparatus of claim 13, further comprising means for updating the threshold when a serving cell of a most recent successful handover is weaker than the strongest candidate target cell.

15. The apparatus of claim 13, in which the threshold is further based at least in part on a greatest difference between the signal strength of the strongest candidate target cell and a signal strength of the at least one previous serving cell, each of the at least one previous serving cells being a serving cell based at least in part on a previous successful handover.

16. The apparatus of claim 13, further comprising means for receiving a target candidate cell from the base station based at least in part on the pruned list.

17. The apparatus of claim 13, in which the at least one previous serving cell of the target RAT was not a strongest candidate target cell at a time of a respective handover to the at least one previous serving cell.

18. A computer program product for wireless communications, the computer program product comprising:
a non-transitory computer-readable medium having program code recorded thereon, the program code comprising:
program code to determine, at a UE, a threshold based at least in part on a signal strength of a strongest candidate target cell of a target radio access technology (RAT) and at least one previous serving cell of the target RAT;
program code to prune a list of candidate target cells of the target RAT, for a handover from a source RAT, based at least in part on the threshold; and
program code to report the pruned list to a base station of the source RAT prior to the handover.

19. The computer program product of claim 18, in which the program code further comprises program code to update the threshold when a serving cell of a most recent successful handover is weaker than the strongest candidate target cell.

20. The computer program product of claim 18, in which the threshold is further based at least in part on a greatest difference between the signal strength of the strongest candidate target cell and a signal strength of the at least one previous serving cell, each of the at least one previous serving cells being a serving cell based at least in part on a previous successful handover.

21. The computer program product of claim 18, in which the program code further comprises program code to receive a target candidate cell from the base station based at least in part on the pruned list.
